(19) United States
(12) Patent Application Publication
(10) Pub. No.: US 2001/0049631 A1
(43) Pub. Date: Dec. 6, 2001

(54) Web-based method for selecting component configurations

(76) Inventors: Kevin Watts, Middleton, CT (US); Muthaiya Rajagopalan, Plainville, CT (US)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 09/681,393

(22) Filed: Mar. 28, 2001

Related U.S. Application Data
(60) Provisional application No. 60/192,800, filed on Mar. 28, 2000.

(51) Int. Cl. G06F 17/60

(52) U.S. Cl. 705/26

(57) ABSTRACT

A network-based method for identifying components for electrical distribution and control products includes receiving component specification information from a user and using a server to compare the received specification information with pre-stored information. The method also includes selecting at least one component which matches the received specification information and downloading to the user information related to the component.

### CROSS REFERENCE TO RELATED APPLICATIONS

This application claims the benefit of U.S. Provisional Application No. 60/192,800 filed Mar. 28, 2000.

### Background of Invention

This invention relates generally to computer network-based wizards and more particularly to a network-based method and system for identifying component configurations and costs associated therewith.

Transformers, and in particular general purpose transformers, are used to provide an operating voltage to a device or devices, such as electric equipment and machinery, that is different than the voltage available at the facility where the device is being used. A primary of the transformer is connected to the electrical supply circuit, or voltage supply, and a secondary of the transformer is used to either step up the supply voltage to a higher voltage or to step down the supply voltage to a lower voltage. Another transformer application is to isolate the equipment from fluctuations in the supply voltages caused by large load fluctuations within the electrical supply circuit. An example of fluctuations within the supply voltages occurs when multiple electric machines are turning off and on within an electric supply circuit.

Identifying a correct transformer for a specific application is not always an easy task. Many parameters should be considered, and each combination of parameters could demand a specific transformer for optimum performance.

Therefore, it would be desirable to quickly determine a proper transformer that should be used for different combinations of parameters. In addition, it would be desirable to determine if a particular transformer provides inadequate performance for equipment, machinery, or a facility.

### SUMMARY OF INVENTION

In an exemplary embodiment, a web-based method for selecting a component includes receiving product specification information from a user and comparing the received product specification information with pre-stored component information. If at least one component matches the received product specification information, the pre-stored component information is downloaded for communication to the user.

The product information may include, for example, features of the product and accessories of the product. The method further includes validating configuration compatibility based on product information data and features of the product to determine whether a resulting product is capable of desired performance for a set of given product parameters.

### BRIEF DESCRIPTION OF DRAWINGS

FIG. 1 is a system block diagram.

FIG. 2 is an expanded version block diagram of a server architecture of a system in accordance with one embodiment of the present invention.

FIG. 3 is a flow diagram of a web-based method for selecting and ordering transformers.

FIG. 4 is an exemplary transformers features page.

FIG. 5 is an exemplary second transformers features page.

FIG. 6 is an exemplary circuit diagram page.

FIG. 7 is an exemplary kVA calculator page.

FIG. 8 is an exemplary exception message page.

FIG. 9 is an exemplary transformers additional features page.

FIG. 10 is an exemplary transformers_applications page.

FIG. 11 is an exemplary instrument tranformers needs assessement page.

FIG. 12 is an exemplary indoor current instrument tranformers application information page.

FIG. 13 is an exemplary indoor current instrument tranformers rating and construction page.

FIG. 14 is an exemplary indoor current instrument tranformers selector page.

FIG. 15 is an exemplary outdoor current instrument tranformers application information page.

FIG. 16 is an exemplary outdoor current instrument tranformers rating and construction page.

FIG. 17 is an exemplary indoor current instrument tranformers selector page.

FIG. 18 is an exemplary indoor voltage instrument transformer application information page.

FIG. 19 is an exemplary indoor voltage instrument transformer rating and construction page.

FIG. 20 is an exemplary indoor voltage instrument transformer selector page.

FIG. 21 is an exemplary outdoor voltage instrument transformer application information page.

FIG. 22 is an exemplary outdoor voltage instrument transformer rating and construction page.

FIG. 23 is an exemplary outdoor voltage instrument transformer selector page.

FIG. 24 is an exemplary instrument transformer cross reference page.

FIG. 25 is an exemplary shopping cart page.

FIG. 26 is a flow diagram depicting the process flow of a web-based method for selecting core and coil transformers.

FIG. 27 is an exemplary embodiment of a Needs Assessment page. and FIG. 28 is an exemplary embodiment of a Features page.

FIG. 29 is an exemplary embodiment of an Exception Message page.

FIG. 30 is an exemplary embodiment of a Bill of Materials page.

### DETAILED DESCRIPTION

Set forth below is a description of exemplary methods and systems for facilitating a component selection. While the methods and systems are sometimes described in the context of transformer selections, the methods and systems are not limited to practice in connection with only transformers. The methods and systems can be used, for example, in connection with selection of any products for electrical distribution and control products, such as, but not limited to, switches, connectors, relays, enclosures, and many other different types of products.

In one exemplary embodiment of a system to facilitate the selection of a transformer for a particular application, a user logs into the system and the system prompts the user, e.g., via a display that prompts the user for inputs, to enter information relating to particulars of the transformer. Once the user inputs information pertaining to a particular transformer application, the systems then obtains, e.g., via a display that prompts the customer for inputs, additional information based on the application. The particular information obtained by the system is determined by the particular application of the transformer. Once the requested information is received by the system, the system recommends a specific transformer for the particular application.

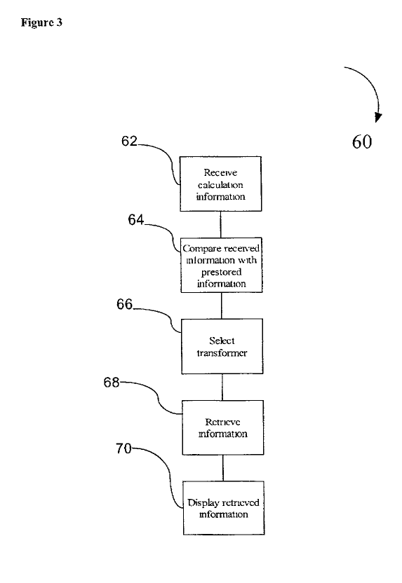

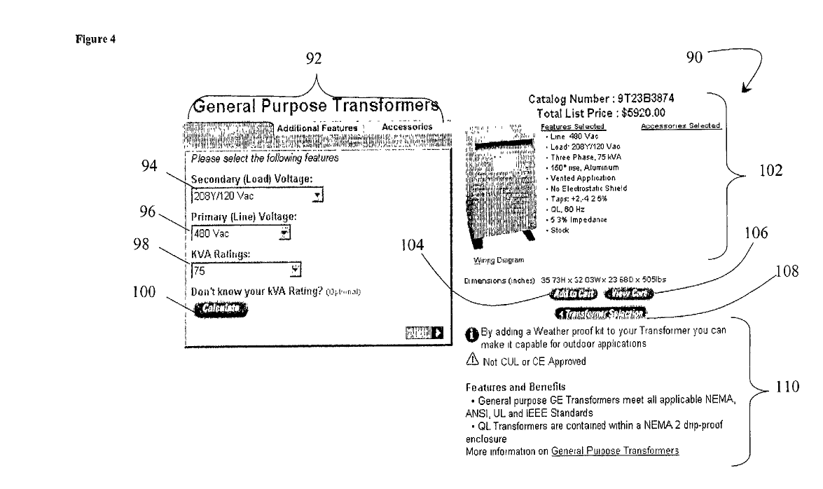

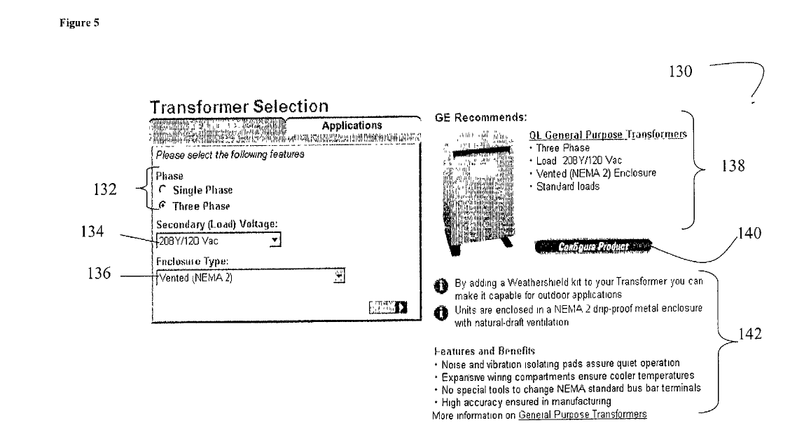

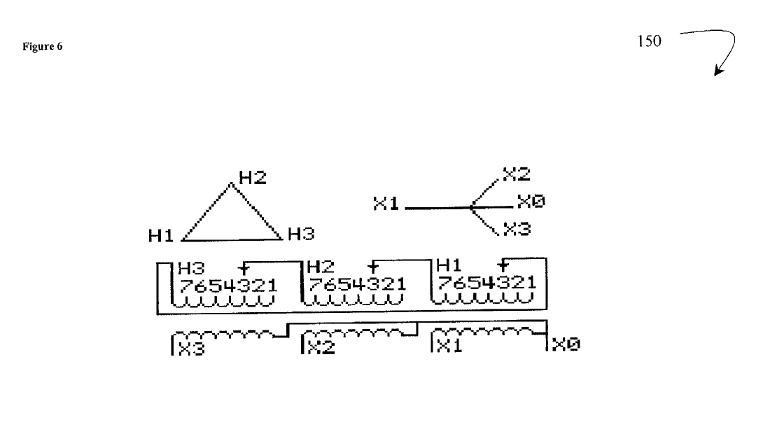

Set forth below are details regarding exemplary hardware architectures (FIGS. 2 and 3), an exemplary process flow chart illustrating processing for various types of transactions (FIG. 4), and exemplary screen shots displayed by the exemplary system to a user desiring a transformer (FIGS. 5-28). Although specific exemplary embodiments of methods and systems for generating term sheets are described herein, the methods and systems are not limited to such specific exemplary embodiments.

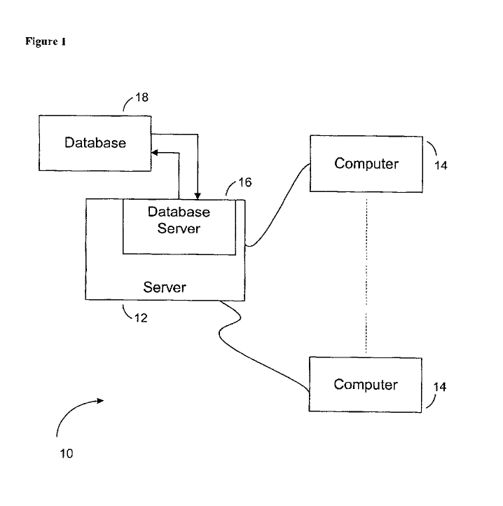

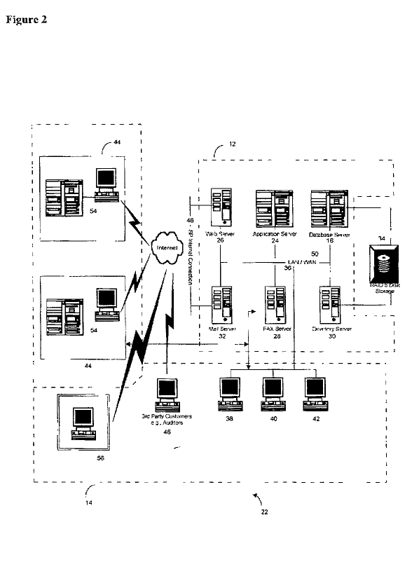

FIG. 1 is a block diagram of a transformer system 10 in accordance with one embodiment of the present invention. System 10 includes a server sub-system 12 and a plurality of user devices 14 connected to server sub-system 12, sometimes referred to herein as server 12. In one embodiment, devices 14 are computers including a web browser, and server 12 is accessible to devices 14 via a network such as an intranet or the Internet. In an alternative embodiment, devices 14 are servers for a network of customer devices.

Devices 14 are interconnected to the network, such as a local area network (LAN) or a wide area network (WAN), through many interfaces including dial-in-connections, cable modems and high-speed ISDN lines. Alternatively, devices 14 are any device capable of interconnecting to a network including a web-based phone or other web-based connectable equipment. Server sub-system 12 includes a database server 16 connected to a centralized database 18 containing transformer information, as described below in greater detail. In one embodiment, centralized database 18 is stored on database server 16 and can be accessed by potential users at one of user devices 14 by logging onto server sub-system 12 through one of user devices 14. In an alternative embodiment centralized database 18 is stored remotely from server sub-system 12.

FIG. 2 is an expanded version block diagram of an exemplary embodiment of a server architecture of a transformer system 22. Components of system 22, identical to components of system 10 (shown in FIG. 1), are identified in FIG. 2 using the same reference numerals as used in FIG. 1. System 22 includes server sub-system 12 and user devices 14. Server sub-system 12 includes database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator workstation 38, a user workstation 40, and a supervisor workstation 42 are coupled to LAN 36. Alternatively, workstations 38, 40, and 42 are coupled to LAN 36 via an Internet link or are connected through an intranet.

Each workstation 38, 40, and 42 is a personal computer having a web browser. Although the functions performed at the workstations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36.

In another embodiment, server sub-system 12 is configured to be communicatively coupled to various individuals or employees 44 and to users 46 via an ISP Internet connection 48. The communication in the exemplary embodiment is illustrated as being performed via the Internet, however, any other wide area network (WAN) type communication can be used in other embodiments, i.e., the systems and processes are not limited to being practiced via the Internet. In addition, and rather than a WAN 50, local area network 36 could be used in place of WAN 50.

In the exemplary embodiment, any authorized individual or an employee of the business entity having a workstation 52 can access server sub-system 12. One of user devices 14 includes a senior manager”s workstation 54 located at a remote location. Workstations 52 and 54 are personal computers having a web browser. Also, workstations 52 and 54 are configured to communicate with server subsystem 12. Furthermore, fax server 28 communicates with employees located outside the business entity and any of the remotely located user systems, including a user system 56 via a telephone link. Fax server 28 is configured to communicate with other workstations 38, 40, and 42 as well.

FIG. 3 is a flow diagram 60 for a web-based method for selecting and ordering transformers. In one embodiment, the transformers are industrial transformers. In an alternative embodiment, the transformers are commercial transformers. In a further alternative embodiment, the transformers are residential transformers. System 10 (shown in FIG. 1) receives 62 product specification information from a user. In one embodiment, the user inputs the information into a device (such as device 14 shown in FIG. 1) which transmits the information to a server (such as server 12 shown in FIG. 1). The product specification information is received from the user via a graphical user interface as will be described in greater detail below.

The received product specification information includes an identification of transformer features and an identification of accessories for the product. Exemplary transformer features include, but are not limited to, phase selection, .e.g., single phase or three phase, secondary (load) voltage, and kVA ratings. Additional features include, but are not limited to, primary (line) voltage, temperature rise, applications, coil materials, and electrostatic shield. Exemplary product accessories features include, but are not limited to, weather proof kit, lug kit, vent guard, and wall mount bracket.

Server 12 compares 64 the received information to pre-stored information accessible by server 12. In one embodiment, the pre-stored information is stored in a database that resides on server 12. In an alternative embodiment, the pre-stored information is stored in a database remote from server 12. The pre-stored information includes the transformer features and accessories information. Server 12 compares the received information to the pre-stored information to determine if any transformers contained in the pre-stored information satisfy the product specifications submitted by the user.

In addition, system 12 assesses the information supplied by the user to validate configuration compatibility of the product. Exemplary information includes product application, product parameters, desired product features, and product accessories. System 10 evaluates the information supplied by the user and determines whether a resulting product incorporating a transformer having the received product specifications is capable of meeting parameters of the indicated product. For example, system 10 determines whether a selected coil material is available for the selected transformer configuration and, if the selected coil material is not available for the selected transformer configuration, system 10 displays a message to the user that the selected coil material is not available for the selected transformer configuration. As another example, system 10 determines whether an electrostatic shield is suggested for use with the selected transformer configuration, and if an electrostatic shield is not selected and is suggested, system 10 displays a message to the user that an electrostatic shield is suggested for the selected transformer configuration.

If the product resulting from the received information does not meet the parameters of the product, system 10 guides a user by providing suggestions for a correct product configuration. In an alternative embodiment, system 10 guides a user by providing information regarding alternative products compatible with the product parameters supplied by the user. In a further alternative embodiment, system 10 guides a user by providing information regarding products that are upgrades for the product parameters supplied by the user.

System 10 then identifies pre-stored transformer information that matches the information entered by the user and selects 66 those transformers pertaining to that pre-stored information. System 10 retrieves 68 transformer information pertaining to the selected transformer. In one embodiment, the transformer information includes a transformer identifier number and associated price for each selected transformer. For example, the transformer identifier number is a catalog number and the price is a list price of the product. Server 12 then transmits the retrieved transformer identifier number and associated price and displays 70 the retrieved information on user device 14 so that the user can view the information. In an alternative embodiment, system 10 uses the list price information to generate a quotation for each selected transformer including the indicated features and accessories and server 12 then transmits the retrieved transformer identifier number and the quotation to user device 14.

System 10 then prompts the user to order one or more of the selected products. If the user is a registered user, system 10 accepts orders online by providing the user a purchase order form and receiving the completed purchase order form from the user. The completed purchase order form is then authenticated against pre-determined criteria to determine whether system 10 should accept the completed purchase order form. If the purchase order form is accepted, the ordered product is then shipped to the user.

If the user is an unregistered user, and the user attempts to order a selected product, system 10 transmits a notification to the user indicating that a sales person or an authorized distributor will contact the user to confirm the order request. System 10 then transmits a notification, such as via email, to a selected person. The selected person then checks the order and instructs system 10 to transmit the order to a field sales regional manager or district manager. The field sales manager then follows-up with the lead or forwards the lead to a distributor with instructions to follow-up with the user that submitted the order.

To implement the process described above, many variations of particular screens viewable by a customer can be utilized. The following description refers to one set of screens that can be used to prompt a user to make the necessary inputs to enable the system to suggest a particular product. Of course many variations of such screens are possible. Refering now again specifically to the drawings, FIGS. 4 through 30 detail navigation through an exemplary web-site linked to system 10 (shown in FIG. 1) via device 14 (shown in FIG. 1) and server 12 (shown in FIG. 1).

FIG. 4 is an exemplary transformers features page 90 including a set of transformers tabs 92 that include tabs for features, additional features, and accessories. The features tab includes secondary (load) voltage pull down menu 94 for specifying a secondary (load) voltage, a primary (line) voltage pull down menu 96 for specifying a primary (line) voltage, and a kVa ratings pull down menu 98 for specifying a kVa rating. In addition, features page 90 includes a calculate button 100 to determine a suggested kVA rating for a selected transformer configuration as described below in greater detail.

Screen shot 90 also includes a recommendation area 102 then includes information about the recommended product, including in one embodiment its catalog number and price. The user has the option of selecting an Add to Cart radio button 104, a View Cart radio button 106, and a Transformer Selection radio button 108. Screen shot 90 further includes an information area 110 that provides further information about the recommended product, including in one embodiment its features and benefits.

FIG. 5 shows an exemplary transformer features page, as depicted in screen shot 130, which includes a set of Phase check boxes 132 for specifying whether a single phase or three phase transformer is desired, a Secondary (Load) Voltage pull down menu 134 for specifying a secondary voltage, and an Enclosure Type pull down menu 136 for specifying an enclosure type. Screen shot 130 also includes a recommendation area 138 that displays information about the recommended product, a Configure Product radio button 140, and an information displayed area 142 that displays further information about the recommended product.

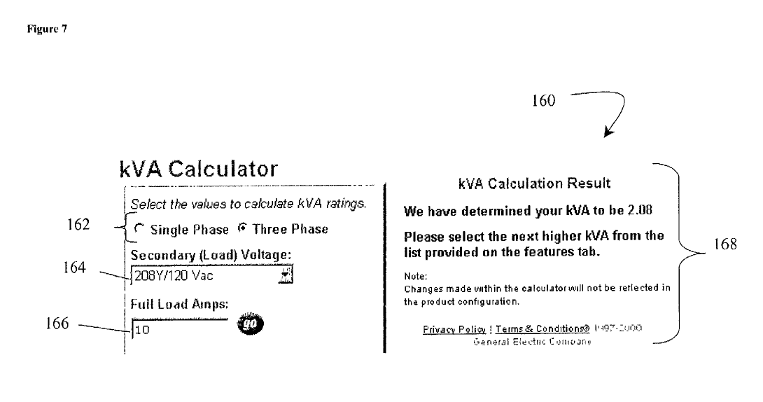

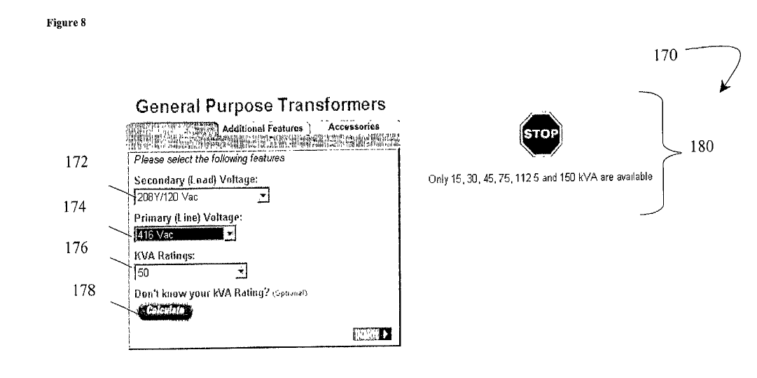

FIG. 6 shows an exemplary circuit diagram page as depicted in screen shot 150 that system 10 (shown in FIG. 1) displays in response to the user selecting with a mouse a graphical depiction of a product, such as that shown in recommendation area 138 of screen shot 130, shown in FIG. 7.

FIG. 7 shows an exemplary embodiment of a kVA calculator, as depicted screen shot 160, which includes a set of selection check boxes 162 for specifying whether the desire transformer is single phase or three phase, a Secondary (Load) Voltage pull down menu 164 for specifying a secondary voltage, and a Full Load Amps text box 166 for specifying a full load amperage. Screen shot 160 includes a kVA calculation result display area 168 to dispose of the kVA calculation.

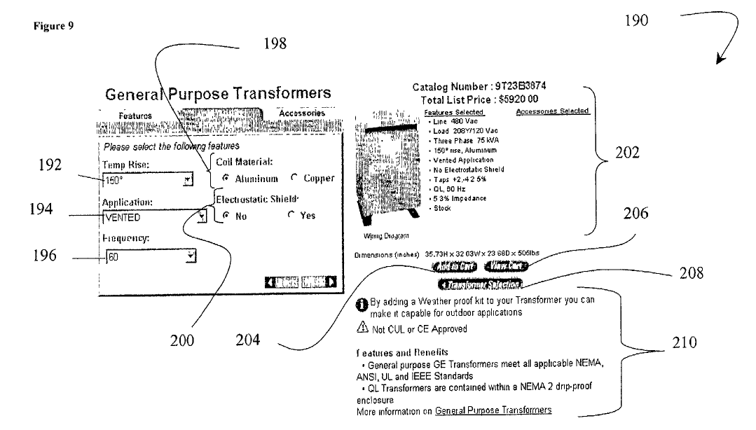

FIG. 8 shows an exemplary embodiment of a transformer exception message page, as depicted in screen shot 170. Screen shot 170 includes a Secondary (Load) Voltage pull down menu 172 for specifying a secondary voltage, Primary (Line) Voltage pull down menu 174 per specifying a primary voltage, a kVA Ratings pull down menu 176 for specifying a kVA rating, and a Calculate radio button 178 for calculating a kVA rating. Screen shot 170 also includes an exception message area of 180 that informs the user that the desired set of attributes are not mutually compatible.

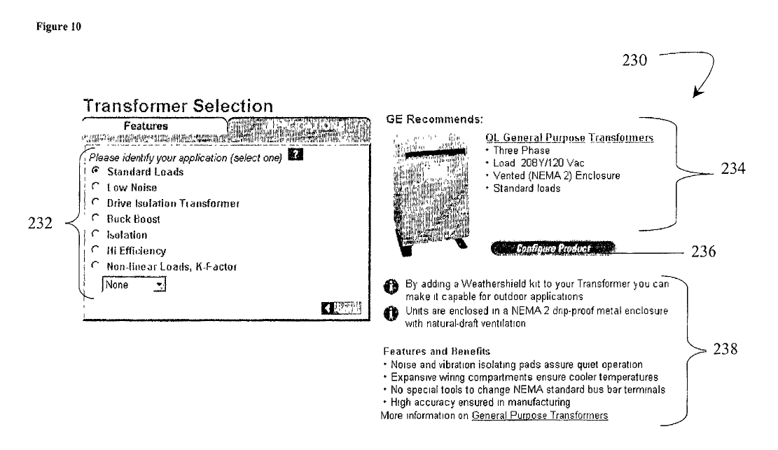

FIG. 9 shows a transformer additional features page, as depicted in screen shot 190, which includes a Temperature Rise pull down menu 192 for specifying a temperature rise, an Application pull down menu 194 for specifying an application, and a Frequency pull down menu 196 for specifying a frequency. Screen shot 190 also includes a set of Coil Material check boxes 198 for specifying aluminum or copper as the coil material, and a set of Electrostatic Shield check boxes 200 for specifying whether an electrostatic shield is desired. Screen shot 190 further includes a recommendation display area 202 that displays information about the recommended product, in one embodiment including its catalog number and price. Screen shot 190 still further includes an Add to Cart radio button 204, a View Cart radio button 206, and a Transformer Selection radio button 208. In addition, screen shot 190 includes a further information display area 210 that displays further information about the recommended transformer.

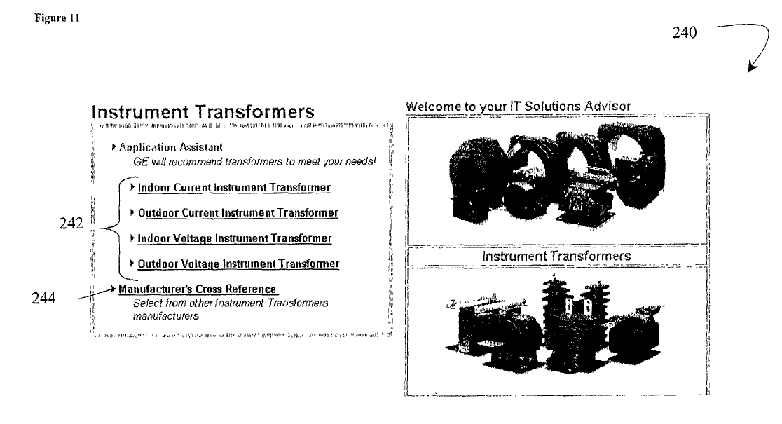

FIG. 10 shows an exemplary embodiment of a transformer selection applications page, as depicted the screen shot 230, which includes a set of application check boxes 232 for specifying the application for which the transformer is desired. Screen shot 230 also includes a recommendation display area 234 that displays information about the recommended product, and a Configure Product radio button 236. Screen shot 230 also includes a further information display area 238 that displays further information about the recommended product.

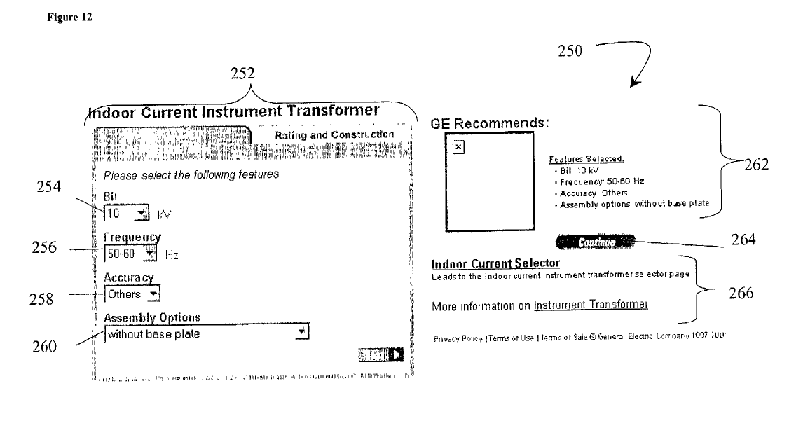

FIG. 11 shows an exemplary embodiment of an instrument transformers needs assessment page, as depicted screen shot 240. Screen shot 240 includes a set of hyperlinks 242 for selecting whether an instrument transformer is for indoor or outdoor use, and for indicating whether current or voltage is the critical parameter influencing choice of transformer. Screen shot 240 also includes a Manufacturer”s Cross Reference hyperlink 244 that allows determination of which transformers made by various manufacturers are equivalent to each other.

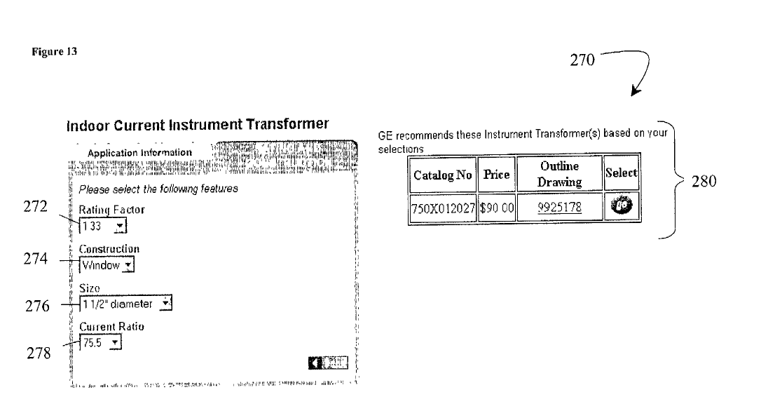

FIG. 12 shows an exemplary embodiment of an indoor current instrument transformer application information page, as depicted in screen shot 250. Screen shot 250 includes a set of tabs 252 for selection of application information or rating and construction. The application information page includes a Bil pull down menu 254, a Frequency pull down menu 256, an Accuracy pull down menu 258, and an Assembly Options pull down menu 260. Screen chat 250 also includes a recommendation area 262 to dispose information about the recommended transformer, a Continue radio button 264, and a further information display area 266.

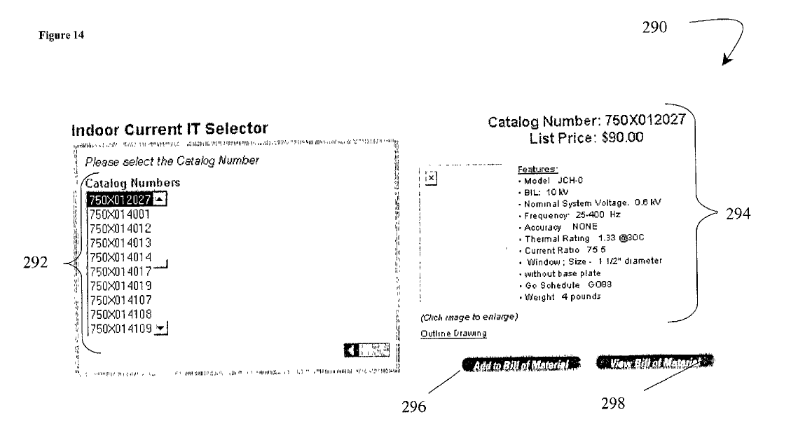

FIG. 13 shows an exemplary embodiment of an indoor current instrument transformer rating and construction page, as depicted in screen shot 270. Screen shot 270 includes a Routing Factor pull down menu 272, a Construction pull down menu 274, a Size pull down menu 276, and a Current Ratio pull down menu 278. Screen shot 270 also includes a recommendation display area 280 that displays information about the recommended product.

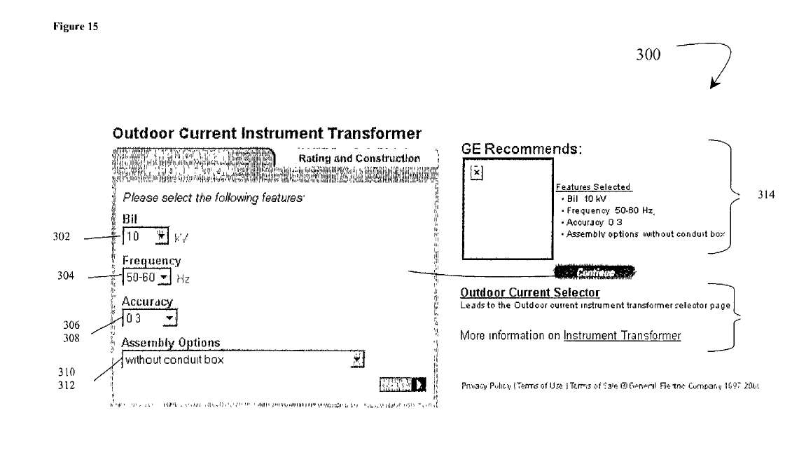

FIG. 14 shows an exemplary embodiment of an indoor current instrument transformer selector page, as depicted in screen shot 290, which includes a Catalog Numbers pull down menu 292 for selection of a catalog number. Screen shot 290 also includes a recommendation display area 294 to include information about the recommended product, in one embodiment including its catalog number and price. Screen shot 290 also includes an Add to Bill of Material radio button 296, and a View Bill of Material radio button 298.

FIG. 15 shows an exemplary embodiment of an outdoor current instrument transformer application information page, as depicted in screen shot 300, which includes a Bil pull down menu 302, a Frequency pull the menu 304, an Accuracy pull down menu 306, and an Assembly Options pull down menu 308. Screen shot 300 also includes a recommendation display area 310 to display information about the recommended transformer, a Continue radio button 312, and a further information display area 314 that displays further information and links to still further information about recommended transformer.

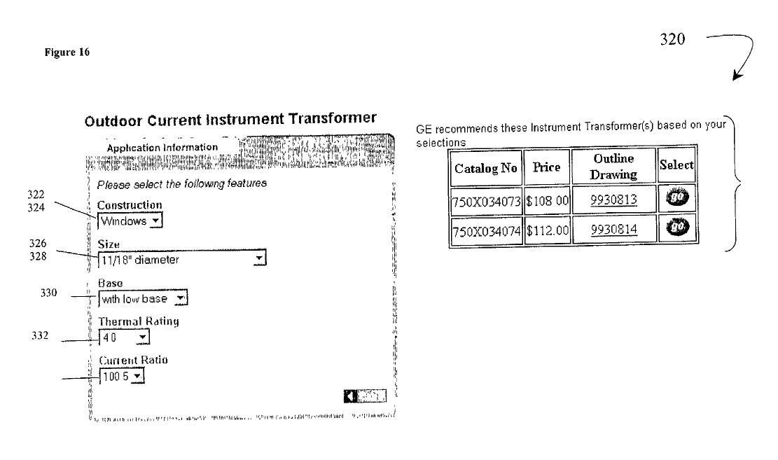

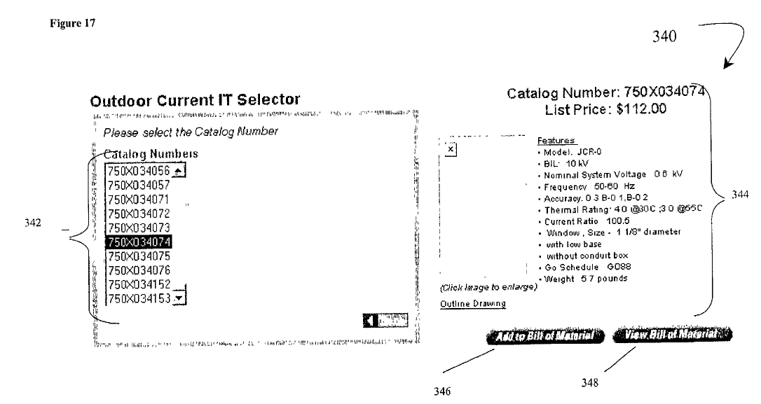

FIG. 16 shows an exemplary embodiment out of an outdoor current instrument transformer routing and construction page, as depicted in screen shot 320. Screen shot 320 includes a Construction pull the menu 322, a Size pull the menu 324, a Base pull down menu 326, a Thermal Rating pull down menu 328, and a Current Ratio pull down menu 330. Screen shot 320 also includes a recommendation display area 332 that displays information about the recommended transformer, including in one embodiment its catalog number and price.

FIG. 17 shows an exemplary embodiment of an outdoor current instrument transformer selector page, as depicted in screen shot 340, which includes a Catalog Numbers pull down menu 342. Screen shot 340 includes a recommendation display area of 344 to display information about the recommended transformer, including in one embodiment its catalog number and price. Screen shot 340 also includes an Add to Bill of Material radio button 246, and a View Bill of Material radio button 348.

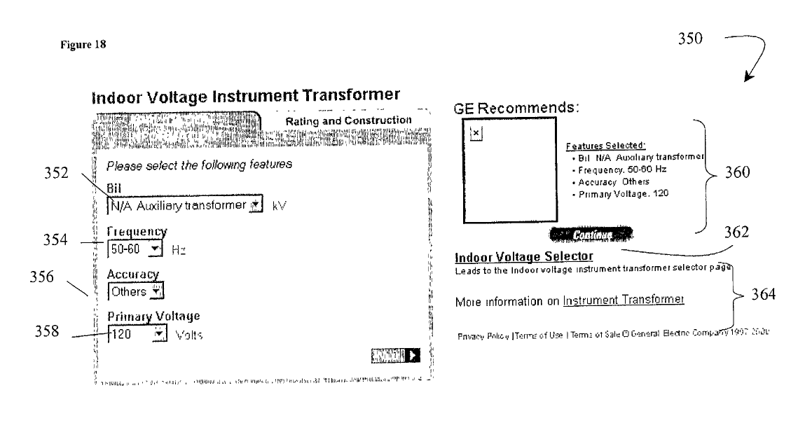

FIG. 18 shows an exemplary embodiment out of indoor voltage instrument transformer application information page, as depicted in screen shot 350. Screen shot 350 includes a Bil pull down menu 352, a Frequency pull down menu 354, an Accuracy pull down menu 356, and a Primary Voltage pull down menu 358. Screen shot 350 also includes a recommendation display area 360 to displays information about the recommended transformer, a Continue radio button 362, and a further information display area 364 to display further information about the recommended transformer, including hyperlinks to still further information.

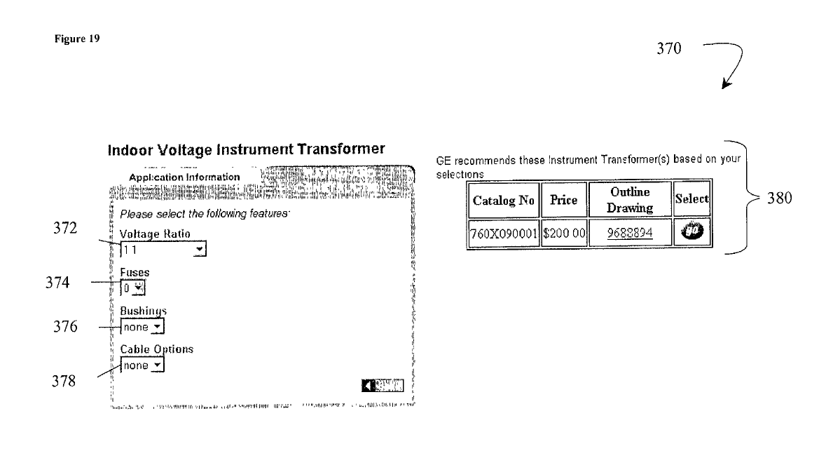

FIG. 19 shows an exemplary embodiment of an indoor instrument transformer rating and construction page, as depicted in screen shot 370. Screen shot 370 includes a Voltage Ratio pull down menu 372, a Fuses pull down menu 374, a Bushings pull down menu 376, and a Cable Options pull down menu 378. Screen shot 370 also includes a recommendation display area 380 to display information about the recommended transformer, including in one embodiment embodiment its catalog number and price.

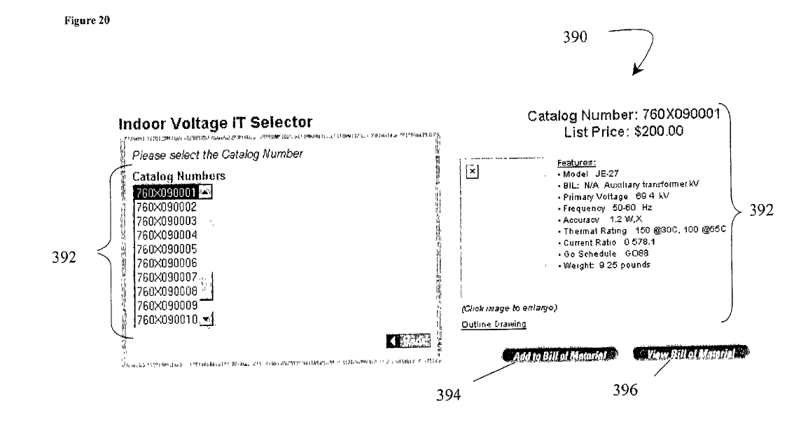

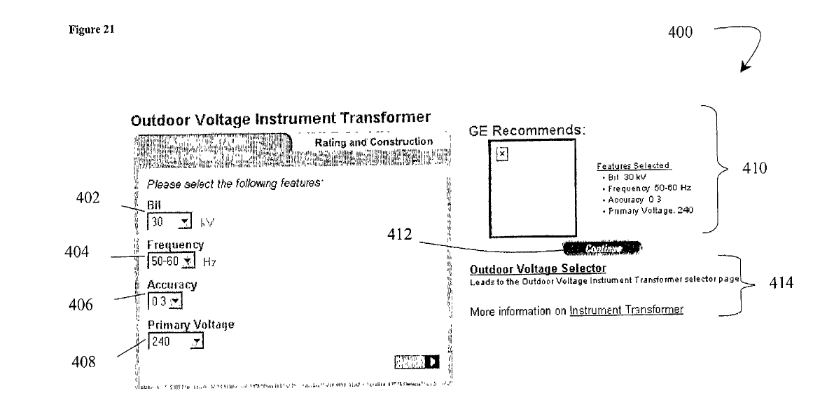

FIG. 20 shows an exemplary embodiment of an instrument transformer selector page, as depicted in screen shot 390, which includes a Catalog Numbers pull down menu 392. Screen shot 390 also includes a recommendation display area 392 that in one embodiment includes the catalog number and price of the recommended transformer. Screen shot 390 also includes an Add to Bill of Material radio button 394, and a Bill of Material radio button 396.

FIG. 21 shows an exemplary embodiment of an outdoor voltage instrument transformer application information page, as depicted in screen shot 400. Screen shot 400 includes a Bil pull down menu 402, a Frequency pull down menu 404, an Accuracy pull down menu 406, and a Primary Voltage pull down menu 408. Screen shot 400 also includes a recommendation display area 410 that displays information about the recommended transformer, a Continue radio button 412, and a further information display area 414 to display further information and hyperlinks relating to be recommended transformer.

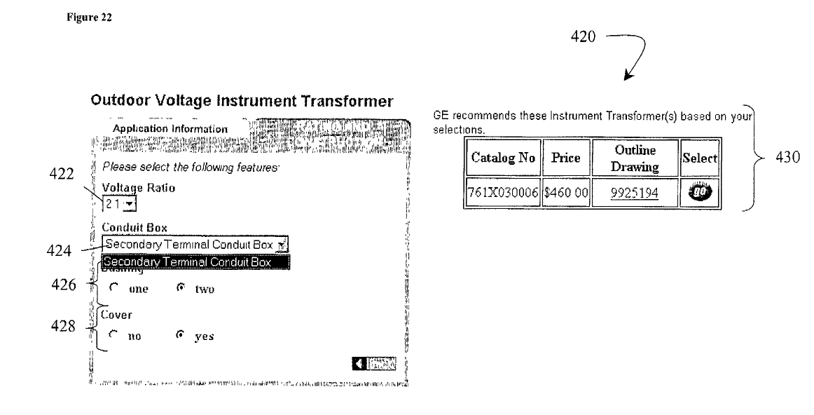

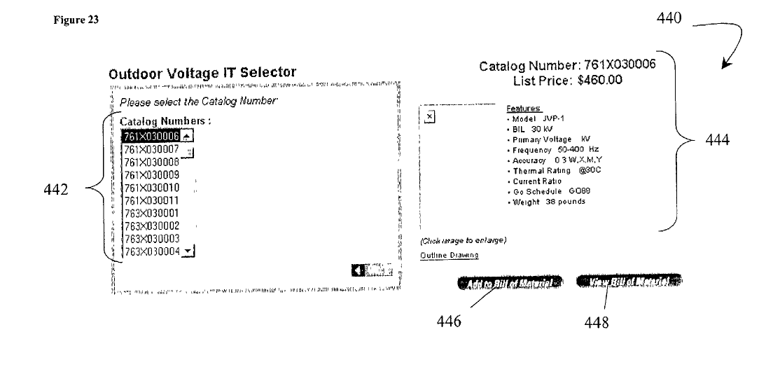

FIG. 22 shows an exemplary embodiment of an outdoor voltage instrument transformer rating and construction page, as depicted in screen shot 420. Screen shot 420 includes a Voltage Ratio pull down menu 422, a Conduit Box pull down menu 424, a set of Bushing check boxes 426 for specifying whether one or to bushings is desired, and a set of Cover check boxes 428 for indicating whether a cover is desired. Screen shot 420 includes a recommendation display area 430 to displays information about the recommended transformer, including in one embodiment its catalog number and price.

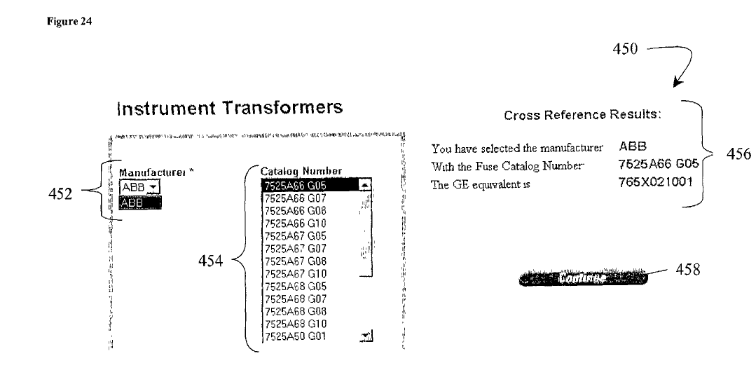

FIG. 23 shows an exemplary embodiment of an outdoor voltage instrument transformer selector page, as depicted in screen shot 440, which includes a Catalog Numbers pull down menu 442. Screen shot 440 also includes a recommendation display area 444 to display information about the recommended transformer, including one embodiment its catalog number and price. Screen shot 440 also includes an Add to Bill of Material radio button 446, and a View Bill of Material radio button 448.

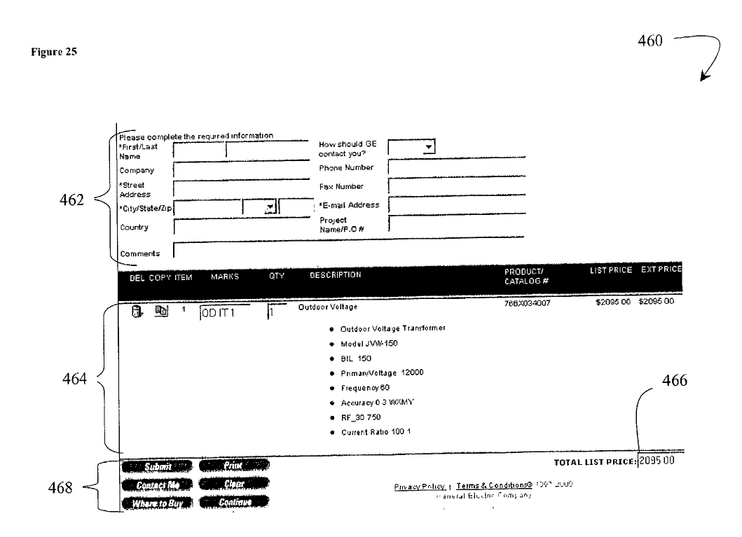

FIG. 24 shows an exemplary embodiment of an instrument transformers cross reference page, as depicted in screen shot 450, which includes a Manufacturer pull down menu 452 and a Catalog Number pull down menu 454. Screen shot 450 also includes a cross references results display area 456 that displays in one embodiment the selected manufacturer and the selected catalog number along with the catalog number of the equivalent product from another manufacturer. Screen shot 450 also includes a Continue radio button 458.

FIG. 25 shows an exemplary embodiment of a Bill of Material page, as depicted in screen shot 460. Screen shot 460 includes a customer contact information area 462, and an order area 464 that displays details of the order, in one embodiment including a product description, a quantity, a catalog number, and a price. Screen shot 460 also includes a Total List Price display area 466 to displays the total list price of all the selected products. Screen shot 460 also includes a set of radio buttons 468 the user to choose a Submit option, a Print option, a Contact Me option, a Clear option, a Where to Buy option, and a Continue option.

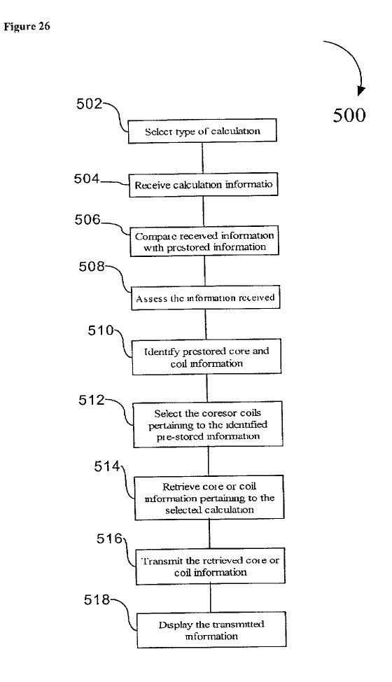

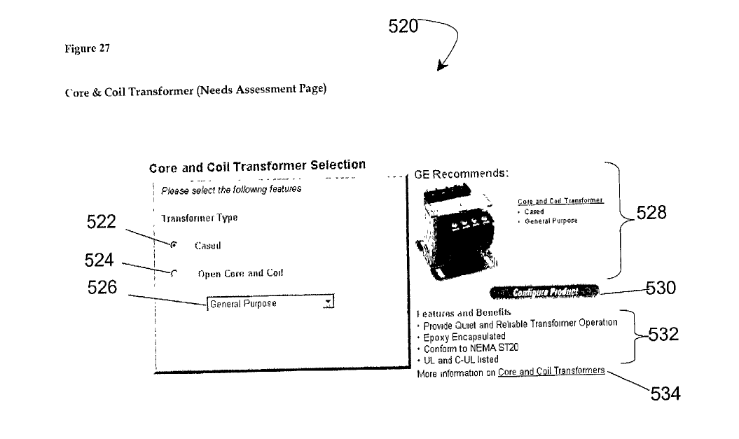

Another embodiment of the present invention is directed toward selection of core and coil transformers. FIG. 26 is a flow diagram 500 for a web-based method for selecting core and coil transformers. In one embodiment, the core and coil transformer calculation includes at least one of a transformer type, a transformer purpose, a secondary voltage, a primary voltage, a tap arrangement, a kVA rating, and a load frequency. System 10 (shown in FIG. 1) receives 502 information regarding the selection of the desired calculation, and then receives 504 calculation information from a user. In one embodiment, the user inputs the information into a device (such as device 14 shown in FIG. 1) that transmits the information to a server (such as server 12 shown in FIG. 1). The product specification information is received from the user via a graphical user interface as will be described in greater detail below.

Server 12 compares 506 the received information to pre-stored information accessible by server 12. In one embodiment, the pre-stored information is stored in a database that resides on server 12. In an alternative embodiment, the pre-stored information is stored in a database remote from server 12. The pre-stored information includes the transformer features. Server 12 compares the received information to the pre-stored information to determine if any transformers contained in the pre-stored information satisfy the specifications submitted by the user.

In addition, server system 12 assesses 508 the information received from the user to validate configuration compatibility of the product. Exemplary information includes product application, product parameters, desired product features, and product accessories. System 10 evaluates the information received from the user and determines whether a resulting product having the received product specifications is capable of meeting parameters of the indicated product. System 10 reviews the user input and based on a pre-determined transformer configuration as well as operating specifications, the user is provided feedback for a specific product that meets the criteria for user application.

If the product resulting from the received information does not meet the parameters of the product, system 10 guides a user by providing suggestions for a correct product configuration. In an alternative embodiment, system 10 guides a user by providing information regarding alternative products compatible with the product parameters supplied by the user.

System 10 then identifies 510 pre-stored transformer information that matches the information entered by the user and selects 508 those transformer pertaining to the identified pre-stored information. System 10 retrieves 514 transformer information pertaining to the selected calculation. Server 12 then transmits 516 the retrieved transformer information and displays 518 the retrieved transformer information to user device 14 so that the user can view the information.

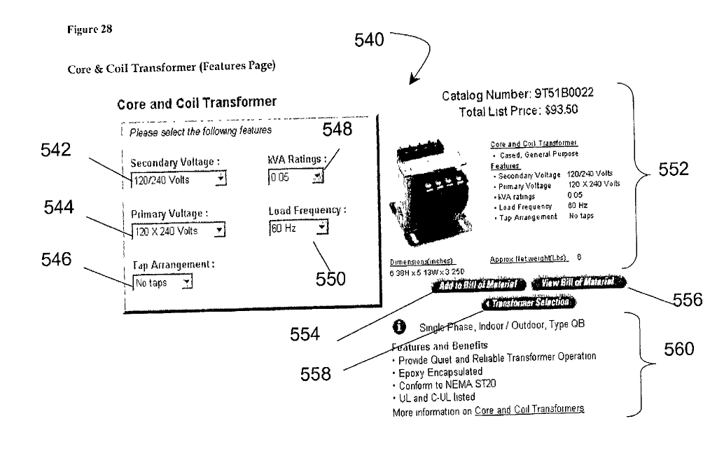

FIG. 27 shows an exemplary embodiment of a Core and Coil Transformer (Needs Assessment) page, as depicted in screen shot 520, which system 10 (shown in FIG. 1) displays when a link is selected on a product page. Screen shot 520 includes a check box 522 for specifying whether the transformer type is cased, a check box 524 for specifying whether the transformer type is Open Core and Coil, and a pull down menu 526 for specifying the purpose of the transformer. Screen shot 100 also includes a recommendation area 528, that displays the results of the core and coil transformer calculation, a Configure Product button 530, and a Features and Benefits area 532 that displays the features and benefits of the transformer that system 10 recommends. Screen shot 520 further includes a Core and Coil Transformers link 534, selection of which results in system 10 transmitting more information regarding the core and coil transformers specified from device 14 (shown in FIG. 1) to server 12 (shown in FIG. 1), where the input information is compared with pre-stored information that is retrieved and displayed on device 14.

FIG. 28 shows an exemplary embodiment of a Features page, as depicted in screen shot 540, which system 10 (shown in FIG. 1) displays to allow selection of the features of the core and coil transformer. Screen shot 540 includes a pull down menu 542 for specifying a secondary voltage, a pull down menu 544 for specifying a primary voltage, a pull down menu 546 for specifying a tap arrangement, a pull down menu 548 for specifying a kVA rating, and a pull down menu 550 for specifying load frequency. Screen shot 540 includes a recommendation area 552 for displaying the results of the core and coil transformer calculation and recommending a compatible product as determined by system 10. In one embodiment, transformer information includes a transformer identifier number and associated price for each selected transformer. In one embodiment, the transformer identifier number is a catalog number and the price is a list price of the product. Server 12 then transmits the retrieved transformer identifier number and associated price and displays the retrieved transformer information on user device 14 (shown in FIG. 1) so that the user can view the information. In an alternative embodiment, system 10 uses the list price information to generate a quotation for each selected transformer including the indicated features and accessories and server 12 then transmits the retrieved transformer identifier number and the quotation to user device 14.

Screen shot 540 also includes an Add to Bill of Material link 554, a View Bill of Material link 556, and a Transformer Selection link 558, selection of which results in system 10 transmitting information specified from device 14 (shown in FIG. 1) to server 12 (shown in FIG. 1), where the input information is compared with pre-stored information that is received and displayed on device 14. Selection of Add to Bill of Material link 554 or View Bill of Materials link 556 results in transmitting to user device 14 a bill of materials as described below in greater detail. Screen shot 540 also includes a Features and Benefits area 560 that includes a Core and Coil Transformers link that provides further information on core and coil transformers. Selection of link 554 results in system 10 transmitting information regarding the core and coil transformers specified from device 14 to server 12, and places an order for the transformer recommended in recommendation area 552. In an alternative embodiment, system 10 uses the list price information to generate a quotation for each selected transformer including the indicated features and accessories and server 12 then transmits the retrieved transformer identifier number and the quotation to user device 14.

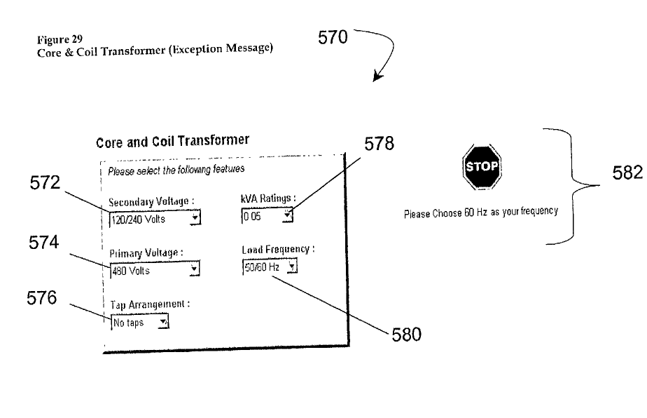

FIG. 29 shows an exemplary embodiment of an Exception Message page, as depicted in screen shot 570, that results from incompatible user selections. Screen shot 570 includes a pull down menu 572 for specifying a secondary voltage, a pull down menu 574 for specifying a primary voltage, a pull down menu 576 for specifying a tap arrangement, a pull down menu 578 for specifying a kVA rating, and a pull down menu 580 for specifying a load frequency. Screen shot 570 also includes an exception message 582 that indicates to the user that the present set of selections in pull down menus 572, 574, 576, and 578 are not compatible with the load frequency selected in pull down menu 580.

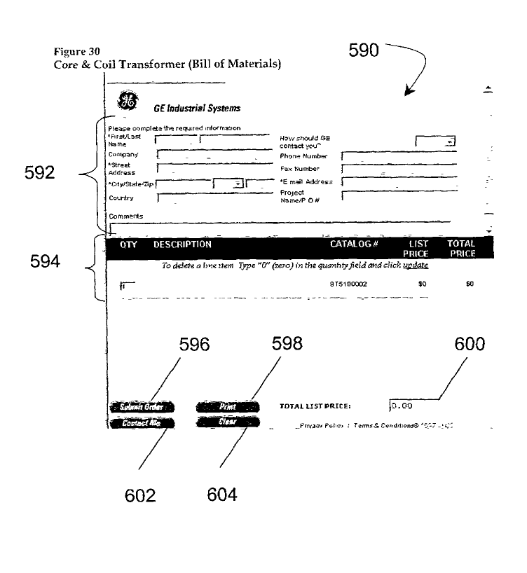

FIG. 30 shows an exemplary embodiment of a Bill of Materials page, as depicted in screen shot 590. Screen shot 590 includes a customer information area 592, where user contact information can be inserted, and an order description area 594 that displays the quantity, description, catalog number, list price, and total price of the items ordered. Screen shot 590 also includes a Submit Order link 596 and a Print link 598, selection of which results in system 10 transmitting information regarding the core and coil transformers specified from device 14 (shown in FIG. 1) to server 12 (shown in FIG. 1), where the input information is used to place an order for the indicated product. Screen shot 590 further includes a Total List Price display area 600, a Contact Me link 602, and a Clear link 604.

System 10 facilitates an easy and efficient method for identifying and ordering transformers. System 10 is network based and is configured to permit users to access system 10 from remote locations through devices 14.

While the invention has been described in terms of various specific embodiments, those skilled in the art will recognize that the invention can be practiced with modification within the spirit and scope of the claims.

1. A method for facilitating selection of a product for an electrical distribution and control system using a network-based system including a server and at least one device connected to the server via a network, said method comprising the steps of:
receiving product specification information from a user via the device;
comparing the received product specification information with pre-stored product information;
selecting at least one product which matches the received product specification information; and
downloading information related to the selected product.

2. A method in accordance with claim 1 wherein the product is a transformer.

3. A method in accordance with claim 2 wherein the transformer is a core and coil transformer.

4. A method in accordance with claim 1 wherein said step of receiving product specification information comprises the step of receiving features information for the product.

5. A method in accordance with claim 2 wherein said step of receiving product specification information comprises the step of receiving transformer information including at least one of coil material and electrostatic shield.

6. A method in accordance with claim 5 wherein said step of comparing the received product specification information comprises the steps of:
determining whether the coil material selected is available for the selected transformer configuration; and
displaying a message if the selected coil material is not available for the selected transformer configuration.

7. A method in accordance with claim 5 wherein said step of comparing the received product specification information comprises the steps of:
determining whether an electrostatic shield is suggested for use with the selected transformer configuration; and
displaying a message if an electrostatic shield is not selected and if an electrostatic shield is suggested.

8. A method in accordance with claim 1 wherein said step of receiving product information data from a user further comprises the step of receiving an identification of accessories for the product.

9. A method in accordance with claim 1 wherein said step of downloading information related to the selected product comprises the step of downloading at least one of the features selected for the product and the accessories selected for the product.

10. A method in accordance with claim 1 wherein said step of downloading information related to the selected product comprises the step of downloading a catalog number and list price for the selected product and generating a quotation for the selected product.

11. A method in accordance with claim 1 wherein the product specification information is received from the user via a graphical user interface.

12. A method in accordance with claim 1 further comprising the step of assessing a need of the user based on at least one of a product application, product parameters, desired product features, and product accessories.

13. A method in accordance with claim 12 further comprising the step of validating configuration compatibility based on the received product specification information to determine whether a resulting product incorporating a selected product having the received product specifications is capable of meeting parameters of the product.

14. A method in accordance with claim 13 further comprising the step of guiding the user, if the resulting product does not meet the parameters of the product, to a correct product configuration.

15. A method in accordance with claim 12 further comprising the step of guiding the user to a compatible product.

16. A method in accordance with claim 1 wherein said step of receiving product specification information from a user via the device comprises the step of receiving at least one of industrial, commercial, and residential product specification information from the user.

17. A system for facilitating selection of a component for an electrical distribution and control product, said system comprising:
a device; and
a server connected to said device and configured to receive component information data from a user via said device, the component information including at least one of a feature of the component and an accessory of the component, said server further configured to identify stored component information data that matches the component information data entered by the user.

18. A system in accordance with claim 17 wherein the component is a transformer.

19. A system in accordance with claim 17 wherein the transformer is a core and coil transformer.

20. A system in accordance with claim 17 wherein said server further configured to select at least one component from the stored component information data which matches the component identification data entered by the user.

21. A system in accordance with claim 17 wherein said server further configured to download to the user information related to the selected component.

22. A system in accordance with claim 18 wherein said server further configured to select at least one transformer that includes at least one of a coil material and electrostatic shield.

23. A system in accordance with claim 22 wherein said server further configured to: determine whether the coil material selected is available for the selected transformer configuration; and
display a message if the selected coil material is not available for the selected transformer configuration.

24. A system in accordance with claim 22 wherein said server further configured to:
determine whether an electrostatic shield is suggested for use with the selected transformer configuration; and
display a message, if an electrostatic shield is not selected and if an electrostatic shield is suggested.

25. A system in accordance with claim 17 wherein said server further configured to generate a quotation for each selected component.

26. A system in accordance with claim 17 wherein said server further configured to accept a purchase order for the component after the purchase order has been authenticated against pre-determined criteria.

27. A system in accordance with claim 17 wherein said device configured to be a server for a network of customer devices.

28. A system in accordance with claim 17 wherein said server and said device are connected via at least one of a wide area network, a local area network and the Internet.

29. A system in accordance with claim 17 wherein said server further configured to receive at least one of industrial, commercial, and residential product specification information from the user.

30. A computer programmed to:
prompt a user to select a component of an electrical distribution and control product;
prompt a user to provide information required to generate a component recommendation for the product; and
generate the recommendation using the user provided information.

31. A computer in accordance with claim 30 wherein to prompt a user to select a component, said computer displays a computer generated screen listing a plurality of at least one of features, accessories, applications, and options.

32. A computer in accordance with claim 30 wherein to prompt a user to provide information required to generate a component recommendation, said computer displays a computer generated screen listing a plurality of information boxes.

33. A computer in accordance with claim 32 further programmed to search a database to identify components which match criteria supplied by the user in response to prompting the user to provide information required to generate the recommendation and to display to the user at least some information relating to at least some of the components identified as a match from the database search.

34. A computer in accordance with claim 32 further programmed to prompt a user to select at least one of the identified components, and wherein to generate the component recommendation, said computer populates the document with data related to the one identified component.

35. A computer in accordance with claim 30 wherein the component comprises a component for an electrical distribution and control product.

36. Apparatus comprising:
means for prompting a user to select a component for an electrical distribution and control product;
means for prompting the user to provide information regarding selected component; and
means for transmitting to the user a recommendation for a particular component.

37. Apparatus in accordance with claim 36 wherein said means for prompting a user to select a component comprises means for displaying a computer generated screen listing a plurality of component selections.

38. Apparatus in accordance with claim 36 wherein said component comprises a transformer.

39. Apparatus in accordance with claim 36 wherein said means for prompting a user to provide information comprises means for displaying a computer generated screen listing at least one of features, application, accessories, and options.

40. Apparatus in accordance with claim 36 further comprising means for searching a database to identify components which match criteria supplied by the user in response to prompting the user to provide information regarding the selected components, and means for displaying to the user at least some information relating to at least some of the components identified from the database search.
